(19) United States
(12) Patent Application Publication
(10) Pub. No.: US 2025/0333118 A1
(43) Pub. Date: Oct. 30, 2025

(54) EXTENDABLE VEHICLE CARGO BED

(71) Applicant: Ford Global Technologies, LLC, Dearborn, MI (US)

(72) Inventors: Michael John Harmon, Northville, MI (US); Frank Thomas Brown, Santa Fe, NM (US); Kendra Marie Rabineau, Berkley, MI (US); Max Tran, Pascoe Vale (AU); Leigh H. Cosentino, Woodend (AU); Andrew Beard, Glenaroua (AU); Robert Arthur Johnson, Toledo, OH (US); Michael M. Azzouz, Farmington, MI (US)

(21) Appl. No.: 18/645,056

(22) Filed: Apr. 24, 2024

(51) Int. Cl. B62D 33/02; B60J 1/18; B62D 33/08

(52) U.S. Cl. CPC B62D 33/02; B60J 1/1853; B62D 33/08

(57) ABSTRACT

A vehicle assembly includes a cab back assembly that separates a cargo bed area of a vehicle from a passenger compartment of the vehicle. The cab back assembly is movable between a standard bed position and an extended bed position. A cargo bed floor has an extended floor region that extends into the passenger compartment when the cab back assembly is in the standard bed position. The extended floor region is aft of the passenger compartment when the cab back assembly is in the extended bed position.

### TECHNICAL FIELD

This disclosure relates generally to a cargo bed for a vehicle and, more particularly, to a cargo bed that can be extended to provide more space for carrying cargo.

### BACKGROUND

Vehicles, such as pickup trucks, can include a cargo bed aft of a passenger compartment. A cab back assembly is positioned between the passenger compartment and the cargo bed to separate the cargo bed area from the passenger compartment. In some pickup trucks, such as unibody pickup trucks, a cab back assembly provides both a back of a passenger compartment of the vehicle, and a front wall of the cargo bed of the vehicle.

### SUMMARY

In some aspects, the techniques described herein relate to a vehicle assembly, including: a cab back assembly that separates a cargo bed area of a vehicle from a passenger compartment of the vehicle, the cab back assembly movable between a standard bed position and an extended bed position; and a cargo bed floor having an extended floor region that extends into the passenger compartment when the cab back assembly is in the standard bed position, the extended floor region aft of the passenger compartment when the cab back assembly is in the extended bed position.

In some aspects, the techniques described herein relate to a vehicle assembly, wherein the vehicle is a unibody vehicle having a unibody configuration.

In some aspects, the techniques described herein relate to a vehicle assembly, wherein the vehicle is an electrified vehicle.

In some aspects, the techniques described herein relate to a vehicle assembly, wherein the extended floor region is configured to support a rear row of seats when the cab back assembly is in the standard bed position.

In some aspects, the techniques described herein relate to a vehicle assembly, wherein the rear row of seats are folded when the cab back assembly is in the extended bed position.

In some aspects, the techniques described herein relate to a vehicle assembly, wherein the cab back assembly slides relative to the extended floor region when moved between the extended bed position and the standard bed position.

In some aspects, the techniques described herein relate to a vehicle assembly, wherein the cab back assembly slides on a pair of upper tracks that are above the extended floor region of the cargo bed floor, and a pair of lower tracks that are below the extended floor region.

In some aspects, the techniques described herein relate to a vehicle assembly, wherein the extended floor region extends continuously and uninterruptedly from a standard floor region of the cargo bed floor, the extended floor region aft of the passenger compartment when the cab back assembly is in the standard bed position.

In some aspects, the techniques described herein relate to a vehicle assembly, wherein the extended floor region of the cargo bed floor extends directly from the standard floor region of the cargo bed floor without a gap between the extended floor region and the standard floor region.

In some aspects, the techniques described herein relate to a vehicle assembly, wherein the cab back assembly includes a rear window of the vehicle, the rear window moving with other portions of the cab back assembly back-and-forth between the extended bed position and the standard bed position.

In some aspects, the techniques described herein relate to a vehicle assembly, wherein the cab back assembly includes a rear window and a front wall that is below the rear window, the front wall moving relative to the rear window when the cab back assembly is moved back-and-forth between the extended bed position and the standard bed position.

In some aspects, the techniques described herein relate to a vehicle assembly, wherein a front wall of the cab back assembly is pivoted to a position where the cab back assembly is in front of the extended floor region when the cab back assembly is in the extended bed position.

In some aspects, the techniques described herein relate to a vehicle assembly, wherein the front wall is vertically oriented when the cab back assembly is in the standard bed position.

In some aspects, the techniques described herein relate to a vehicle assembly, wherein the front wall includes a flip-up panel that is configured to provide a front wall when the cab back assembly is in the extended bed position.

In some aspects, the techniques described herein relate to a vehicle cargo bed extending method, including: separating a passenger compartment of a vehicle from a cargo bed area using a cab back assembly in a standard bed position; and moving the cab back assembly from the standard bed position to an extended bed position, the cab back assembly positioned aft of an extended floor region of a cargo bed floor when the cab back assembly is in standard bed position such that the extended floor region is disposed in the passenger compartment of the vehicle, the extended floor region aft of the passenger compartment when the cab back assembly is in the extended bed position.

In some aspects, the techniques described herein relate to a vehicle cargo bed extending method, further including sliding the cab back assembly back-and-forth between the standard bed position and the extended bed position.

In some aspects, the techniques described herein relate to a vehicle cargo bed extending method, further including sliding a rear window of the cab back assembly together with other portions of the cab back assembly back-and-forth between the standard bed position and the extended bed position.

In some aspects, the techniques described herein relate to a vehicle cargo bed extending method, further including pivoting the cab back assembly back-and-forth between the standard bed position and the extended bed position.

In some aspects, the techniques described herein relate to a vehicle cargo bed extending method, wherein the extended floor region is configured to support a rear row of seats when the cab back assembly is in the standard bed position.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of vehicle having a cab back assembly in a standard bed position according to an exemplary embodiment of the present disclosure.

FIG. 2 illustrates a top view of a cargo bed floor from the vehicle of FIG. 1 and showing the cargo bed floor having an extended floor region and standard floor region.

FIG. 3 illustrates the vehicle of FIG. 1 with a rear row of seats in a folded position.

FIG. 4 illustrates the vehicle of FIG. 3 with the cab back assembly moved to an extended bed position.

FIG. 5 illustrates the vehicle of FIG. 4 with a user loading cargo into an extended cargo bed area provided by the can back assembly in the extended bed position.

FIG. 6 illustrates a vehicle according to another exemplary aspect of the present disclosure where the vehicle includes a cab back assembly having a front wall that moves relative to a rear window to transition a cab back assembly to and from an extended bed position that is shown in FIG. 6.

FIG. 7 shows a vehicle according to yet another exemplary aspect of the present disclosure with a cab back assembly in a standard bed position.

FIG. 8 illustrates the vehicle of FIG. 7 with the cab back assembly transitioning to an extended bed position by pivoting the cab assembly.

FIG. 9 illustrates the vehicle of FIG. 8 with the cab back assembly pivoted closer to the extended bed position.

FIG. 10 illustrates the vehicle of FIG. 9 with a flip-up panel of the cab back assembly pivoting to an extended bed position.

FIG. 11 illustrates the vehicle of FIG. 10 with the cab back assembly in the extended bed position.

FIG. 12 illustrates the vehicle of FIG. 11 with the cab back assembly in the extended bed position and at least one user loading cargo into the extended cargo bed area provided by the cab back assembly in the extended bed position.

### DETAILED DESCRIPTION

This disclosure relates generally to vehicle that can provide an extended bed by moving a cab back assembly from a standard bed position to an extended bed position. When the cab back assembly is in the extended bed position, a length of the cargo bed is extended. The cab back assembly can be part of a pickup truck and can separate the cargo bed area from a passenger compartment.

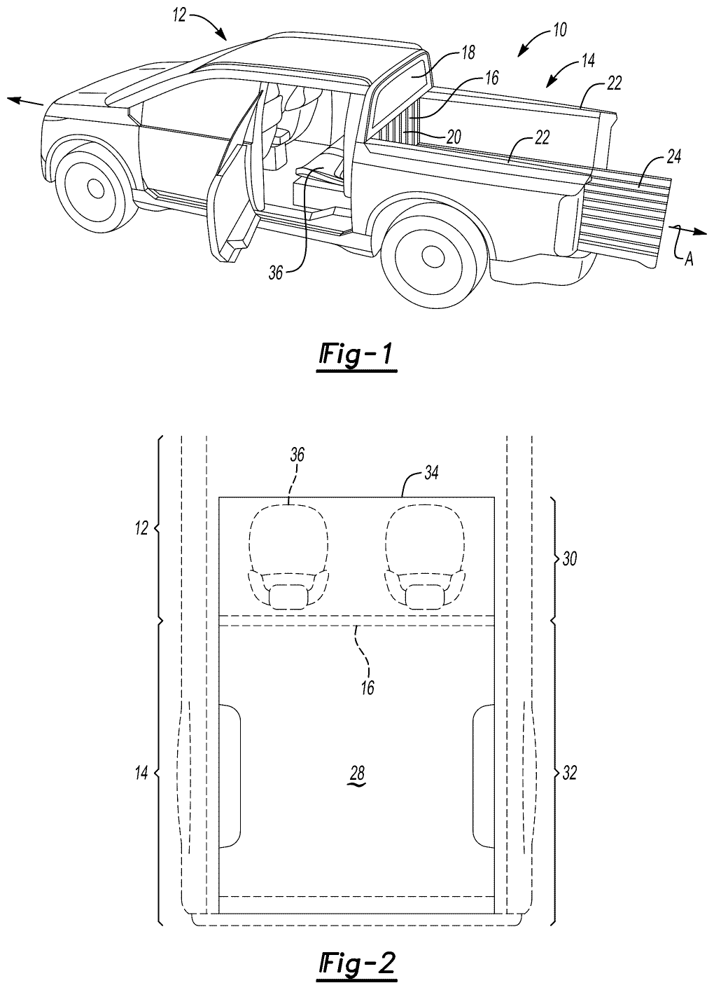

With reference to FIG. 1, the vehicle 10 includes a passenger compartment 12 and a cargo bed 14. Along a longitudinal axis A of the vehicle 10, the cargo bed 14 is aft of the passenger compartment 12.

A cab back assembly 16 separates the passenger compartment 12 from a cargo bed area provided by the cargo bed 14. The cab back assembly 16, in this example, includes a rear window 18 of the passenger compartment 12 and a front wall 20 that is vertically beneath the rear window 18. The front wall 20 establishes a front of the cargo bed 14. Sidewalls 22 establish, at least partially, outboard sides of the cargo bed 14. A tailgate 24, when closed, can establish a rear side of the cargo bed 14.

In the exemplary embodiment, the vehicle 10 is a pickup truck. The vehicle could be another type of vehicle in another example, such as a car, van, sport utility vehicle, etc.

The vehicle 10, in the exemplary embodiment, has a unibody configuration. In another embodiment the vehicle 10 could have a body-on-frame architecture.

The example vehicle 10 is an electrified vehicle. In particular, the vehicle 10 is a battery electric vehicle. In another example, the vehicle 10 could be another type of electrified vehicle, such as a plug-in hybrid electric vehicle (PHEV), or a conventional vehicle.

As the vehicle 10 is an electrified vehicle 10, the vehicle 10 includes an electrified powertrain capable of applying a torque from an electric machine (e.g., an electric motor) to drive one or more drive wheels of the vehicle 10. The vehicle 10 includes, in this example, a traction battery pack to power the electric machine(s), and potentially, other electrical loads of the vehicle 10. The powertrain of the vehicle 10 electrically propels the drive wheels without the assistance of an internal combustion engine in this example.

The cab back assembly 16 separates the cargo bed 14 from the passenger compartment 12. The cab back assembly 16 is movable to transition the cargo bed 14 from the standard bed position of FIG. 1 to an extended bed position.

With reference to FIG. 2, the cargo bed 14 includes a cargo bed floor 28 having an extended floor region 30 and a standard floor region 32. The extended floor region 30 does not necessarily extend to a forwardmost end 34 to the cargo bed floor 28.

When the cab back assembly 16 is in the standard bed position shown in broken lines in FIG. 2, the standard floor region 32 provides substantially all of the floor area for the cargo bed 14. When the cab back assembly 16 is in the extended bed position, the standard floor region 32 and the extended floor region 30 together provide the floor area for the cargo bed 14.

When the cab back assembly 16 is in the standard bed position of FIGS. 1 and 2, the extended floor region 30 extends into the passenger compartment 12 such that the extended floor region 30 is disposed in the passenger compartment 12. When the cab back assembly 16 is in the standard bed position, the extended floor region 30 extends forward past the cab back assembly 16. A row of rear seats 36 can be supported on the extended floor region 30 when the cab back assembly 16 is in the standard bed position.

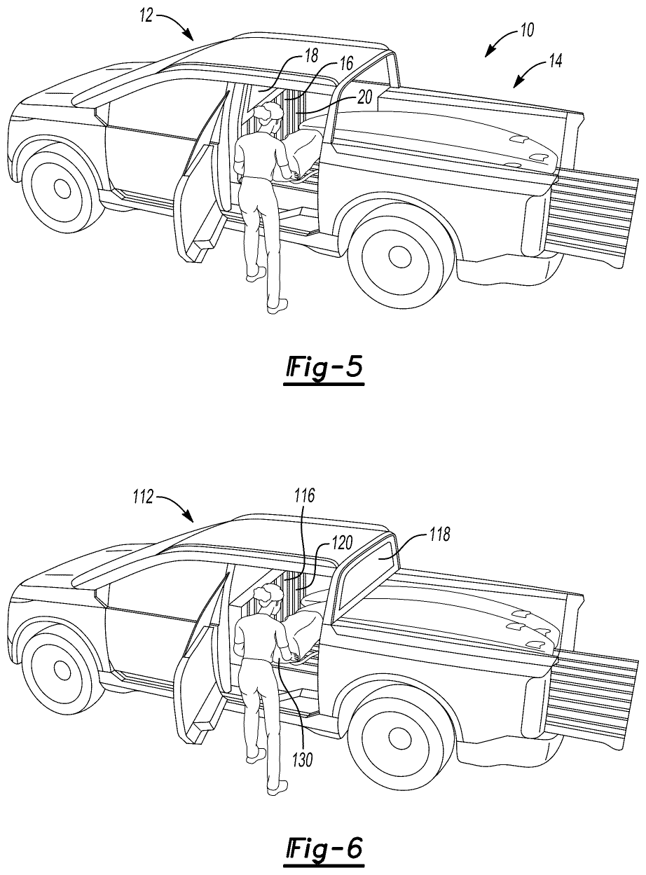

To move the cab back assembly 16 from the standard bed position of FIG. 1 to the extended bed position of FIGS. 4 and 5, the rear seats 36 are first folded up as shown in FIG. 2. Next, the cab back assembly 16, which includes the rear window 18 and the front wall 20, slides forward over the extended floor region 30 such that the extended floor region 30, which was forward the cab back assembly 16 when the cab back assembly 16 was in the standard bed position, is now aft of the cab back assembly 16. When the cab back assembly 16 is in the extended bed position, the extended floor region 30 is aft of the passenger compartment 12.

In this example, the cab back assembly 16 slides on a pair of upper tracks 38 and a pair of lower tracks 40 when transitioning back-and-forth between the standard bed position and the extended bed position (FIG. 4). The upper tracks 38 are above the extended floor region 30. The lower tracks 40 are beneath the extended floor region 30. The cab back assembly 16 can seal against other structures of the vehicle 10 when in the extended bed position.

Notably, the extended floor region 30 extends continuously and uninterruptedly directly from the standard floor region 32 of the cargo bed floor. That is, the example extended floor region 30 extends from the standard floor region 32 without any sort of gap between the extended floor region 30 and the standard floor region 32. The extended floor region 30 extending seamlessly from the standard floor region 32 can eliminate an obstacle to loading material and cargo into the cargo bed 14.

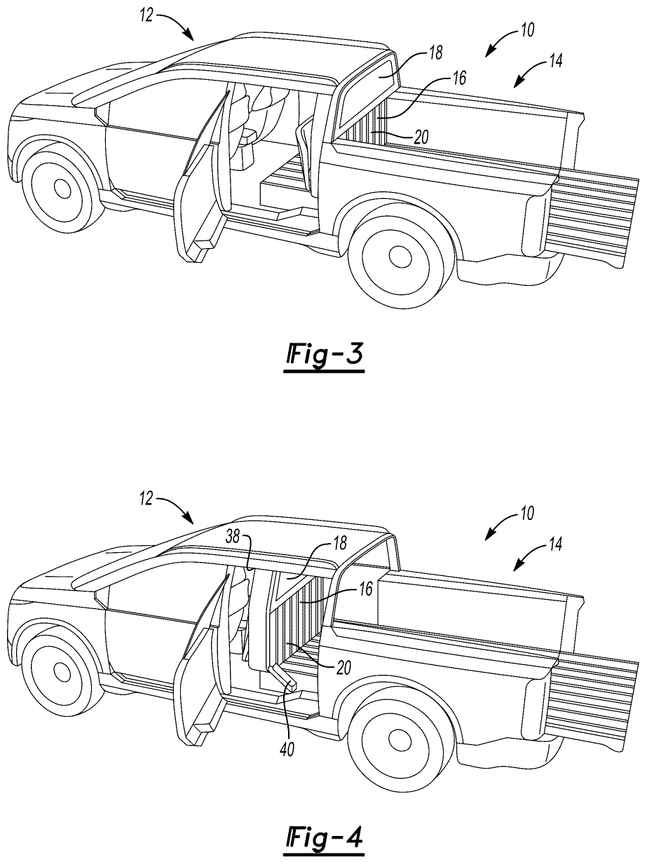

With reference to FIG. 6, a variation of the embodiment shown in FIGS. 1-5 is presented. In FIG. 6, a cab back assembly 116 includes a front wall 120 that moves relative to a rear window 118 when the cab back assembly 116 moves from the standard bed position to the extended bed position shown in FIG. 5.

An extended floor region 130 of the embodiment of FIG. 5 extends into a passenger compartment 112 when the cab back assembly 116 is in the standard bed position. The extended floor region 130 can support a rear row of seats when the cab back assembly 116 is in the standard bed position.

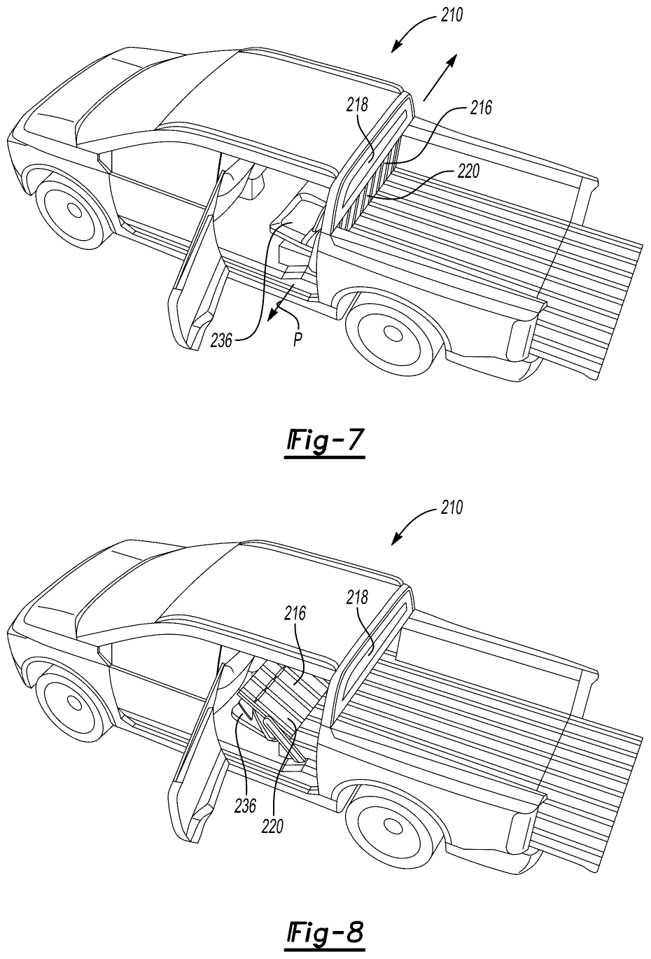

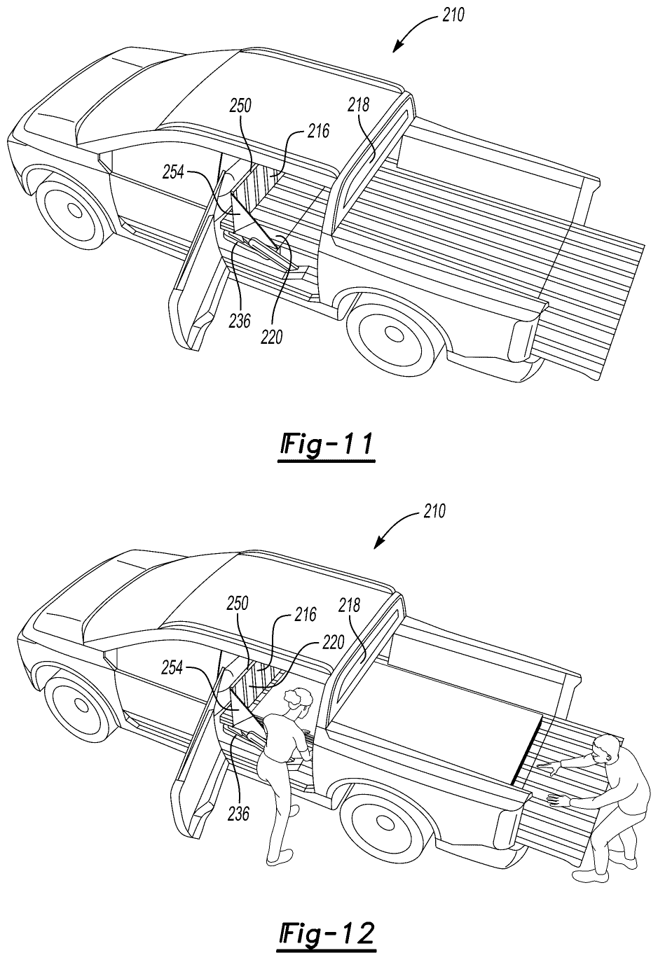

With reference now to FIGS. 7-12, another exemplary embodiment is described in connection with a vehicle 210. The vehicle 210 includes a cab back assembly 216 that pivots about a pivot axis P when moving back-and-forth between the standard bed position of FIG. 7 and the extended bed position of FIGS. 11 and 12.

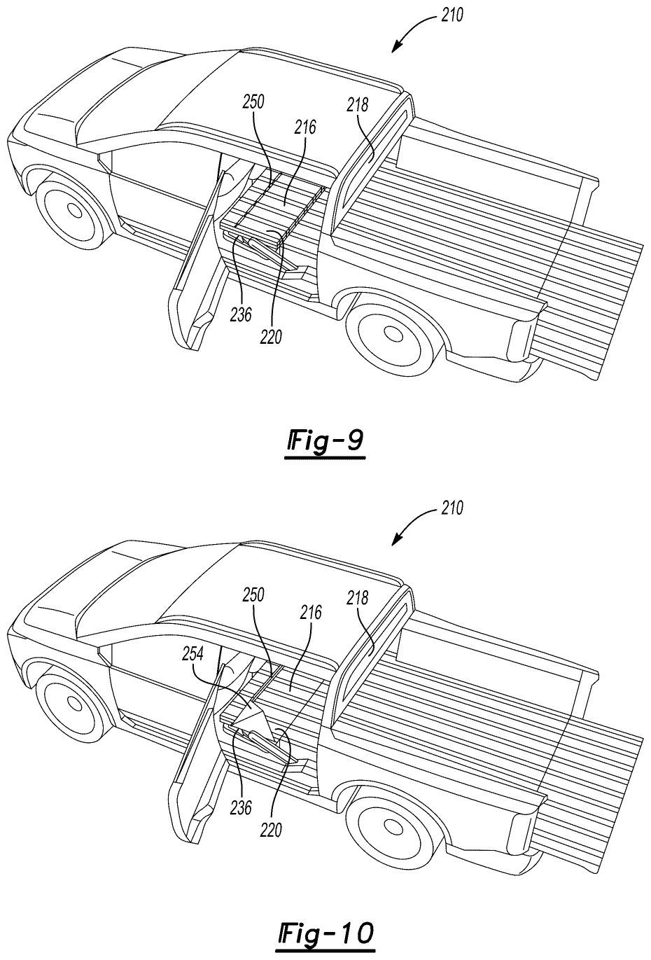

A front wall 220 of the cab back assembly 216 pivots relative to a rear window 218 of the cab back assembly 216 when moving back-and-forth between the standard bed position and the extended bed position. As shown in FIG. 8, when the cab back assembly 216 pivots from the standard bed position of FIG. 7, a row or rear seats 236 folds as the front wall 220 pivots. The front wall 220 pivots from a position where the front wall is substantially vertically oriented to a position where the front wall 220 is substantially horizontally aligned as shown in FIG. 9.

The example cab back assembly 216 includes a flip-up panel 250 that then pivots upward from the position of FIG. 9, to the position of FIG. 10, until reaching the position of FIGS. 11 and 12, which places the cab back assembly 216 in the extended bed position. The flip-up panel 250 provides a front wall of the cargo bed 214 when the cab back assembly 216 is in the extended bed position. In some examples, the flip-up panel 250 can secure to pillar structures of the vehicle 210 to secure the flip-up panel 250 in the position of FIGS. 11 and 12.

Foldable side wings 254 can connect the flip-up panel 250 to remaining portions of the cab back assembly 216. The foldable side wings 254 can additionally help contain material loaded into the cargo bed 114 when the cab back assembly 216 is in the extended bed position. The flip-up panel 250 can block forward movement of the material toward the front of the vehicle.

As shown in FIG. 12, sheets of material can be placed into the cargo bed when the cab back assembly 216 is in the extend bed position due to the additional area provided by the extended floor region.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle assembly, comprising:
a cab back assembly that separates a cargo bed area of a vehicle from a passenger compartment of the vehicle, the cab back assembly movable between a standard bed position and an extended bed position; and
a cargo bed floor having an extended floor region that extends into the passenger compartment when the cab back assembly is in the standard bed position, the extended floor region aft of the passenger compartment when the cab back assembly is in the extended bed position.

2. The vehicle assembly of claim 1, wherein the vehicle is a unibody vehicle having a unibody configuration.

3. The vehicle assembly of claim 1, wherein the vehicle is an electrified vehicle.

4. The vehicle assembly of claim 1, wherein the extended floor region is configured to support a rear row of seats when the cab back assembly is in the standard bed position.

5. The vehicle assembly of claim 4, wherein the rear row of seats are folded when the cab back assembly is in the extended bed position.

6. The vehicle assembly of claim 1, wherein the cab back assembly slides relative to the extended floor region when moved between the extended bed position and the standard bed position.

7. The vehicle assembly of claim 6, wherein the cab back assembly slides on a pair of upper tracks that are above the extended floor region of the cargo bed floor, and a pair of lower tracks that are below the extended floor region.

8. The vehicle assembly of claim 1, wherein the extended floor region extends continuously and uninterruptedly from a standard floor region of the cargo bed floor, the extended floor region aft of the passenger compartment when the cab back assembly is in the standard bed position.

9. The vehicle assembly of claim 8, wherein the extended floor region of the cargo bed floor extends directly from the standard floor region of the cargo bed floor without a gap between the extended floor region and the standard floor region.

10. The vehicle assembly of claim 1, wherein the cab back assembly includes a rear window of the vehicle, the rear window moving with other portions of the cab back assembly back-and-forth between the extended bed position and the standard bed position.

11. The vehicle assembly of claim 1, wherein the cab back assembly includes a rear window and a front wall that is below the rear window, the front wall moving relative to the rear window when the cab back assembly is moved back-and-forth between the extended bed position and the standard bed position.

12. The vehicle assembly of claim 1, wherein a front wall of the cab back assembly is pivoted to a position where the cab back assembly is in front of the extended floor region when the cab back assembly is in the extended bed position.

13. The vehicle assembly of claim 12, wherein the front wall is vertically oriented when the cab back assembly is in the standard bed position.

14. The vehicle assembly of claim 12, wherein the front wall includes a flip-up panel that is configured to provide a front wall when the cab back assembly is in the extended bed position.

15. A vehicle cargo bed extending method, comprising:
separating a passenger compartment of a vehicle from a cargo bed area using a cab back assembly in a standard bed position; and
moving the cab back assembly from the standard bed position to an extended bed position, the cab back assembly positioned aft of an extended floor region of a cargo bed floor when the cab back assembly is in standard bed position such that the extended floor region is disposed in the passenger compartment of the vehicle, the extended floor region aft of the passenger compartment when the cab back assembly is in the extended bed position.

16. The vehicle cargo bed extending method of claim 15, further comprising sliding the cab back assembly back-and-forth between the standard bed position and the extended bed position.

17. The vehicle cargo bed extending method of claim 16, further comprising sliding a rear window of the cab back assembly together with other portions of the cab back assembly back-and-forth between the standard bed position and the extended bed position.

18. The vehicle cargo bed extending method of claim 15, further comprising pivoting the cab back assembly back-and-forth between the standard bed position and the extended bed position.

19. The vehicle cargo bed extending method of claim 15, wherein the extended floor region is configured to support a rear row of seats when the cab back assembly is in the standard bed position.
